(19) United States
(12) Patent Application Publication
(10) Pub. No.: US 2014/0087031 A1
(43) Pub. Date: Mar. 27, 2014

(54) IMPREGNATION TYPE COMPOSITE FATTY CONFECTIONERY

(71) Applicants: Yutaka Kuwano, Tsurugashima-shi (JP); Ayaka Otsuka, Tsurugashima-shi (JP)

(72) Inventors: Yutaka Kuwano, Tsurugashima-shi (JP); Ayaka Otsuka, Tsurugashima-shi (JP)

(73) Assignee: MEIJI CO., LTD., Koto-ku, Tokyo (JP)

(21) Appl. No.: 14/116,670

(22) PCT Filed: May 25, 2012
(86) PCT No.: PCT/JP2012/063505

§ 371 Date: Nov. 8, 2013

(30) Foreign Application Priority Data
May 25, 2011 (JP) 2011-117131

(51) Int. Cl. A23G 3/54

(52) U.S. Cl. CPC A23G 3/54
USPC 426/103

(57) ABSTRACT

The present invention provides a composite fat-based confectionery comprising a porous food material impregnated with a fat-based confectionery material containing a nonfat milk solids and having a moisture content of 1% by weight or more, wherein the fat-based confectionery material contains at least one sucrose fatty acid ester selected from the group consisting of a sucrose erucic acid ester and a sucrose stearic acid ester having an HLB value of 9 to 11. Such a composite fat-based confectionery has the porous food material sufficiently impregnated with the fat-based confectionery material.

### TECHNICAL FIELD

The present invention relates to a composite fat-based confectionery comprising a porous food material impregnated with a fat-based confectionery material containing a nonfat milk solids and having a moisture content of 1% by weight or more.

### BACKGROUND ART

Methods have been proposed wherein a fat-based confectionery material is impregnated into a porous food material such as baked confectioneries, by reducing a pressure and releasing the reduced pressure, or by reducing a pressure, releasing the reduced pressure and further applying a pressure (Patent Literatures 1 and 2). According to these methods, a fat-based confectionery material permeates into the inner portion of a porous food material and the fat-based confectionery material and the porous food material are unified together, thereby obtaining a composite fat-based confectionery having good texture to the mouth and flavor.

### CITATION LIST

### Patent Literature

Patent Literature 1: International Publication No. WO 97/47207 Patent Literature 2: Japanese Patent Application Laid-Open No. 2004-254529

### SUMMARY OF INVENTION

### Technical Problem

However, when a fat-based confectionery material contains a nonfat milk solids and has a moisture content of 1% by weight or more, the permeation of the fat-based confectionery material does not adequately proceed by the method of Patent Literature 1 or 2, sometimes failing to obtain a composite fat-based confectionery with a satisfactory quality. Fat-based confectionery materials sometimes have a large amount of moisture content in the raw materials, in particular, during a high humidity season such as rainy season or summer time, and often have a moisture content of 1% by weight or more due to the moisture absorbed from the production environment atmosphere. Also, in a case where an aqueous dairy product such as cream and condensed milk, or an aqueous raw material such as a fruit juice and liquor, is used, the moisture content of a fat-based confectionery material sometimes becomes 1% by weight or more. No method has been provided up to date for solving the above inconvenience caused during the production of an impregnation type composite confectionery, which uses a fat-based confectionery material containing a nonfat milk solids and having a moisture content of 1% by weight or more, and for sufficiently impregnating the fat-based confectionery into a porous food material.

An object of the present invention is to obtain a composite fat-based confectionery comprising a porous food material impregnated with a fat-based confectionery material containing a nonfat milk solids and having a moisture content of 1% by weight or more, wherein the fat-based confectionery material is sufficiently impregnated into the porous food material.

### Solution to Problem

The present inventors conducted extensive studies to solve the above problems and found that, when a porous food material is impregnated with a fat-based confectionery material containing a nonfat milk solids and having a moisture content of 1% by weight or more, the fat-based confectionery material smoothly permeates into the porous food material by adding at least one sucrose fatty acid ester selected from the group consisting of a sucrose erucic acid ester and a sucrose stearic acid ester having an HLB value of 9 to 11 to the fat-based confectionery material, thereby obtaining a composite fat-based confectionery in which the fat-based confectionery material is sufficiently impregnated into the porous food material, whereby the present invention has been accomplished.

More specifically, the present invention comprises the following constituent features.

(1) A composite fat-based confectionery comprising a porous food material impregnated with a fat-based confectionery material containing a nonfat milk solids and having a moisture content of 1% by weight or more, wherein the fat-based confectionery material contains at least one sucrose fatty acid ester selected from the group consisting of a sucrose erucic acid ester and a sucrose stearic acid ester having an HLB value of 9 to 11.
(2) The composite fat-based confectionery according to the above (1), wherein a content of the sucrose fatty acid ester in the fat-based confectionery material is 0.1% by weight to 1.0% by weight.
(3) The composite fat-based confectionery according to the above (1) or (2), wherein the fat-based confectionery material and the porous food material are allowed to contact with each other under a reduced pressure condition and subsequently the pressure is returned to atmospheric pressure or a pressure is applied to a higher pressure than atmospheric pressure to impregnate the porous food material with the fat-based confectionery material.
(4) The composite fat-based confectionery according to the above (1) or (2), wherein the fat-based confectionery material and the porous food material are allowed to contact with each other under an atmospheric pressure condition and subsequently a pressure is applied to a higher pressure than atmospheric pressure to impregnate the porous food material with the fat-based confectionery material.
(5) A method for producing a composite fat-based confectionery comprising the step of allowing a porous food material and a fat-based confectionery material containing a nonfat milk solids and having a moisture content of 1% by weight or more to contact with each other under a reduced pressure condition and subsequently returning the pressure to atmospheric pressure or applying a pressure to a higher pressure than atmospheric pressure to impregnate the porous food material with the fat-based confectionery material, wherein the fat-based confectionery material contains at least one sucrose fatty acid ester selected from the group consisting of a sucrose erucic acid ester and a sucrose stearic acid ester having an HLB value of 9 to 11.
(6) A method for producing a composite fat-based confectionery comprising the step of allowing a porous food material and a fat-based confectionery material containing a nonfat milk solids and having a moisture content of 1% by weight or more to contact with each other under an atmospheric pressure condition and subsequently applying a pressure to a higher pressure than atmospheric pressure to impregnate the porous food material with the fat-based confectionery material, wherein the fat-based confectionery material contains at least one sucrose fatty acid ester selected from the group consisting of a sucrose erucic acid ester and a sucrose stearic acid ester having an HLB value of 9 to 11.

### Advantageous Effects of Invention

According to the present invention, a composite fat-based confectionery comprising a porous food material impregnated with a fat-based confectionery material containing a nonfat milk solids and having a moisture content of 1% by weight or more, wherein the fat-based confectionery material is sufficiently impregnated into the porous food material, can be obtained.

### DESCRIPTION OF EMBODIMENTS

The fat-based confectionery material according to the present embodiment may be, needless to say, the chocolate and low-grade chocolate defined under the “Fair Competition Code for Proper Labeling of Chocolate Products” certified by the Japan Fair Trade Commission, and may further encompass fat creams or the like, which are not classified thereunder and may include all kinds of fat-based confectionery materials.

The fat-based confectionery material in the present embodiment contains a nonfat milk solids. The nonfat milk solids refers to dairy ingredients, more specifically, those derived from whole milk powder, skimmed powdered milk, cream powder, whey powder, butter milk powder, fermented milk powder, condensed milk powder, cheese powder, cow's milk, evaporated milk, condensed milk, cream, whey, butter milk, fermented milk, cheese, or the like.

The moisture content of the fat-based confectionery material in the present embodiment is 1% by weight or more, preferably 1 to 3% by weight, and more preferably 1 to 2% by weight. The moisture content is the total amount of the moisture content derived from the raw materials of the fat-based confectionery material and the moisture content absorbed by the fat-based confectionery material from the production environment atmosphere during the production or storage of the fat-based confectionery material. An example of the method for measuring the above moisture content includes a drying under reduced pressure method.

The fat-based confectionery material in the present embodiment contains at least one sucrose fatty acid ester selected from the group consisting of a sucrose erucic acid ester and a sucrose stearic acid ester having an HLB value of 9 to 11. With such a composition, the fat-based confectionery material is smoothly impregnated into a porous food material, and a composite fat-based confectionery in which the fat-based confectionery material is sufficiently impregnated into the porous food material can be obtained. The content of the sucrose fatty acid ester in the fat-based confectionery material to achieve the effects of the present invention is preferably 0.1% by weight to 1.0% by weight (0.1% by weight or more and 1.0% by weight or less), and more preferably 0.2% by weight to 0.6% by weight. When the content of the sucrose fatty acid ester is below 0.1% by weight, the effects of the present invention are minimal. However, the effects of the present invention remain substantially the same even when the content of the sucrose fatty acid ester exceeds 1% by weight, hence being disadvantageous costwise.

The above sucrose fatty acid ester is commercially available. Examples of the commercial sucrose erucic acid ester include Ryoto Sugar Ester ER-190 and Ryoto Sugar Ester ER-290 (both manufactured by Mitsubishi-Kagaku Foods Corporation). Examples of the commercial sucrose stearic acid ester having an HLB value of 9 to 11 include DK ester F-90 and DK ester F-110 (both manufactured by DAI-ICHI KOGYO SEIYAKU CO., LTD.).

The fat-based confectionery material of the present embodiment can be obtained, for example, by mixing, microparticulating, and further kneading raw materials in accordance with a conventional method.

The sucrose fatty acid ester used in the present embodiment can achieve the effects of the present invention even when added either before or after the fat-based confectionery material is microparticulated during the production step of the fat-based confectionery material. However, since the sucrose stearic acid ester having an HLB value of 9 to 11 is in the powder form, when the sucrose stearic acid ester is added after the raw materials other than the sucrose fatty acid ester are microparticulated, the smoothness of a fat-based confectionery material may be impaireded by the sucrose stearic acid ester. When the fat-based confectionery material having a good smooth texture in the mouth is desired, it is desirable to add the sucrose stearic acid ester before the fat-based confectionery material is microparticulated.

The fat-based confectionery material in the present embodiment is not particularly limited other than that it contains a nonfat milk solids, has a moisture content of 1% by weight or more, and contains at least one sucrose fatty acid ester selected from the group consisting of a sucrose erucic acid ester and a sucrose stearic acid ester having an HLB value of 9 to 11, and a raw material commonly used for producing a fat-based confectionery material can be used. Examples of the usable raw material include cocoa mass, cocoa powder, sugar, glucose, lactose, cocoa butter, vegetable oil and fat, lecithin and other emulsifiers, dried fruits, and flavors. Not limiting to those, various kinds of raw materials can be used within the range wherein the restriction of the invention of the present application is satisfied.

When the moisture content of fat-based confectionery material is 1% by weight or more, the viscosity of fat-based confectionery material increases substantially in proportion with the moisture content, thereby reducing the fluidity. When the workability is thus decreases, it is desirable to reduce the viscosity of fat-based confectionery material by adding an emulsifier to assure the fluidity. A known polyglycerol condensed ricinoleic acid ester is preferably used as an emulsifier for the purpose of reducing the viscosity of fat-based confectionery material.

The content of fat-based confectionery material in the composite fat-based confectionery according to the present embodiment varies depending on the type of porous food material, but may be set in any range from about more than 0% to 80%. The content of fat-based confectionery material in the composite fat-based confectionery can be calculated by measuring the weights before and after impregnation.

The porous food material in the present embodiment is not particularly limited and many kinds of porous food material can be used. Examples include baked confectioneries such as biscuits, cookies, crackers, pies, wafers, dried sponge cakes, dried puffs, and rusk; rice confectioneries such as rice cracker bits, rice crackers, and thin rice crackers; puffed starch snacks such as puff snacks; dried fruits or vegetables; and dehydrated tofu. These porous food materials can be produced in accordance with a conventional method.

The impregnation in the present embodiment can be carried out by a known method. More specifically, the methods usable include:

a) the fat-based confectionery material and the porous food material are allowed to contact with each other under a reduced pressure condition and the pressure is returned to atmospheric pressure while the porous food material is coated with the fat-based confectionery material, whereby the fat-based confectionery material is impregnated into the porous food material;
b) the fat-based confectionery material and the porous food material are allowed to contact with each other under a reduced pressure condition and a pressure is applied to a higher pressure than atmospheric pressure while the porous food material is coated with the fat-based confectionery material and subsequently the pressure is returned to atmospheric pressure, whereby the fat-based confectionery material is impregnated into the porous food material; or
c) the fat-based confectionery material and the porous food material are allowed to contact with each other under atmospheric pressure and a pressure is applied to a higher pressure than atmospheric pressure while the porous food material is coated with the fat-based confectionery material and subsequently the pressure is returned to atmospheric pressure, whereby the fat-based confectionery material is impregnated into the porous food material. The fat-based confectionery material is preferably a fat-based confectionery material in a melted state. The above impregnation may be carried out in a hermetically closed system such as a pressure resistant container.

The porous food material into which the fat-based confectionery material is impregnated is taken out, the fat-based confectionery material adhered around the porous food material is removed as necessary by air blow or centrifugal separation, and the material is solidified under cooling to obtain a composite fat-based confectionery in which the fat-based confectionery material is impregnated into the porous food material.

In the specification of the present application, the atmospheric pressure condition refers to a condition in which a pressure is equivalent to the atmospheric pressure outside the environment where the impregnation is carried out, and the reduced pressure condition refers to a condition in which a pressure is lower than the atmospheric pressure outside the environment where the impregnation is carried out. An example of the reduced pressure condition includes 4 to 88 kPa, and 8 to 50 kPa is preferably applied. An example of the pressure when applied to a pressure equal to or higher than the atmospheric pressure includes 0.11 to 1.1 MPa, and 0.15 to 0.8 MPa is preferably applied.

Additionally, in the specification of the present application, the pressure value is shown in the absolute pressure, not the so-called gauge pressure.

### EXAMPLES

Hereinbelow, the present invention is further described in reference to the Examples, but is not limited thereto.

### Example 1

Using 35.484 parts by weight of hen's egg, 25.806 parts by weight of sugar, 25.806 parts by weight of soft flour, and 12.903 parts by weight of butter, a sponge cake was prepared by a conventional method. The sponge cake was cut to a size of 15 mm×15 mm×50 mm and dried at 100° C. for 30 minutes using a circulation drier to obtain a baked confectionery, which is the dried sponge cake.

A fat-based confectionery material was prepared by a conventional method using 32.600 parts by weight of sugar, 21.000 parts by weight of a vegetable oil and fat, 18.000 parts by weight of cocoa mass, 18.000 parts by weight of whole milk powder, 9.000 parts by weight of cocoa butter, 0.5000 parts by weight of lecithin, 0.500 parts by weight of a sucrose stearic acid ester having an HLB value of 9.5 (manufactured by DAI-ICHI KOGYO SEIYAKU CO., LTD., trade name: DK ester F-90), 0.300 parts by weight of a polyglycerol condensed ricinoleic acid ester (manufactured by Taiyo Kagaku Co., Ltd., trade name: Sunsoft No. 818R), and 0.100 parts by weight of a flavor.

1.5 Parts by weight of cow's milk was added to 98.5 parts by weight of the fat-based confectionery material, stirred and mixed to obtain a fat-based confectionery material having a moisture content of 1.8% by weight. 100 Parts by weight of the fat-based confectionery material having a moisture content of 1.8% by weight was adjusted to have a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, the pressure was reduced to 15 kPa using a pressure resistant container and immediately returned to the atmospheric pressure, and the baked confectionery was taken out of the fat-based confectionery material. The fat-based confectionery material adhered around the baked confectionery was removed by air blow and the fat-based confectionery material remained on the baked confectionery was solidified under cooling at 15° C. for 25 minutes to obtain a composite fat-based confectionery in which the fat-based confectionery material was sufficiently impregnated into the baked confectionery. The proportion of the fat-based confectionery material in the composite fat-based confectionery was 75% by weight.

### Example 2

Using 35.484 parts by weight of hen's egg, 25.806 parts by weight of sugar, 25.806 parts by weight of soft flour, and 12.903 parts by weight of butter, a sponge cake was prepared by a conventional method. The sponge cake was cut to a size of 15 mm×15 mm×50 mm and dried at 100° C. for 30 minutes using a circulation drier to obtain a baked confectionery, which is the dried sponge cake.

A fat-based confectionery material was prepared by a conventional method using 32.900 parts by weight of sugar, 21.000 parts by weight of a vegetable oil and fat, 18.000 parts by weight of cocoa mass, 18.000 parts by weight of whole milk powder, 9.000 parts by weight of cocoa butter, 0.5000 parts by weight of lecithin, 0.500 parts by weight of a sucrose stearic acid ester having an HLB value of 9.5 (manufactured by DAI-ICHI KOGYO SEIYAKU CO., LTD., trade name: DK ester F-90), and 0.100 parts by weight of a flavor.

0.9 Parts by weight of cow's milk was added to 99.1 parts by weight of the fat-based confectionery material, stirred and mixed to obtain a fat-based confectionery material having a moisture content of 1.3% by weight. 100 Parts by weight of the fat-based confectionery material having a moisture content of 1.3% by weight was adjusted to a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, the pressure was reduced to 15 kPa using a pressure resistant container and immediately returned to the atmospheric pressure, and the baked confectionery was taken out of the fat-based confectionery material. The fat-based confectionery material adhered around the baked confectionery was removed by air blow and the fat-based confectionery material remained on the baked confectionery was solidified under cooling at 15° C. for 25 minutes to obtain a composite fat-based confectionery in which the fat-based confectionery material was sufficiently impregnated into the baked confectionery. The proportion of the fat-based confectionery material in the composite fat-based confectionery was 75% by weight.

### Example 3

Using 35.484 parts by weight of hen's egg, 25.806 parts by weight of sugar, 25.806 parts by weight of soft flour, and 12.903 parts by weight of butter, a sponge cake was prepared by a conventional method. The sponge cake was cut to a size of 15 mm×15 mm×50 mm and dried at 100° C. for 30 minutes using a circulation drier to obtain a baked confectionery, which is the dried sponge cake.

A fat-based confectionery material was prepared by a conventional method using 32.400 parts by weight of sugar, 21.000 parts by weight of a vegetable oil and fat, 18.000 parts by weight of cocoa mass, 18.000 parts by weight of whole milk powder, 9.000 parts by weight of cocoa butter, 0.5000 parts by weight of lecithin, 0.500 parts by weight of a sucrose stearic acid ester having an HLB value of 9.5 (manufactured by DAI-ICHI KOGYO SEIYAKU CO., LTD., trade name: DK ester F-90), 0.500 parts by weight of a polyglycerol condensed ricinoleic acid ester (manufactured by Taiyo Kagaku Co., Ltd., trade name: Sunsoft No. 818R), and 0.100 parts by weight of a flavor.

2.6 Parts by weight of cow's milk was added to 97.4 parts by weight of the fat-based confectionery material, stirred and mixed to obtain a fat-based confectionery material having a moisture content of 2.8% by weight. 100 Parts by weight of the fat-based confectionery material having a moisture content of 2.8% by weight was adjusted to a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, the pressure was reduced to 15 kPa using a pressure resistant container and immediately returned to the atmospheric pressure, and the baked confectionery was taken out of the fat-based confectionery material. The fat-based confectionery material adhered around the baked confectionery was removed by air blow and the fat-based confectionery material remained on the baked confectionery was solidified under cooling at 15° C. for 25 minutes to obtain a composite fat-based confectionery in which the fat-based confectionery material was sufficiently impregnated into the baked confectionery. The proportion of the fat-based confectionery material in the composite fat-based confectionery was 75% by weight.

### Example 4

Using 35.484 parts by weight of hen's egg, 25.806 parts by weight of sugar, 25.806 parts by weight of soft flour, and 12.903 parts by weight of butter, a sponge cake was prepared by a conventional method. The sponge cake was cut to a size of 15 mm×15 mm×50 mm and dried at 100° C. for 30 minutes using a circulation drier to obtain a baked confectionery, which is the dried sponge cake.

A fat-based confectionery material was prepared by a conventional method using 32.400 parts by weight of sugar, 21.000 parts by weight of a vegetable oil and fat, 18.000 parts by weight of cocoa mass, 18.000 parts by weight of butter milk powder, 9.000 parts by weight of cocoa butter, 0.5000 parts by weight of lecithin, 0.500 parts by weight of a sucrose stearic acid ester having an HLB value of 9.5 (manufactured by DAI-ICHI KOGYO SEIYAKU CO., LTD., trade name: DK ester F-90), 0.500 parts by weight of a polyglycerol condensed ricinoleic acid ester (manufactured by Taiyo Kagaku Co., Ltd., trade name: Sunsoft No. 818R), and 0.100 parts by weight of a flavor.

2.6 Parts by weight of cow's milk was added to 97.4 parts by weight of the fat-based confectionery material, stirred and mixed to obtain a fat-based confectionery material having a moisture content of 2.8% by weight. 100 Parts by weight of the fat-based confectionery material having a moisture content of 2.8% by weight was adjusted to have a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, the pressure was reduced to 15 kPa using a pressure resistant container and immediately returned to the atmospheric pressure, and the baked confectionery was taken out of the fat-based confectionery material. The fat-based confectionery material adhered around the baked confectionery was removed by air blow and the fat-based confectionery material remained on the baked confectionery was solidified under cooling at 15° C. for 25 minutes to obtain a composite fat-based confectionery in which the fat-based confectionery material was sufficiently impregnated into the baked confectionery. The proportion of the fat-based confectionery material in the composite fat-based confectionery was 75% by weight.

### Example 5

A composite fat-based confectionery in which a fat-based confectionery material was sufficiently impregnated into a baked confectionery was obtained by producing in the same manner as in Example 1, except that the sucrose fatty acid ester used was a sucrose stearic acid ester having an HLB value of 11 (manufactured by DAI-ICHI KOGYO SEIYAKU CO., LTD., trade name: DK ester F-110). The proportion of the fat-based confectionery material in the composite fat-based confectionery was 75% by weight.

### Example 6

A composite fat-based confectionery in which a fat-based confectionery material was sufficiently impregnated into a baked confectionery was obtained by producing in the same manner as in Example 1, except that the sucrose fatty acid ester used was a sucrose erucic acid ester having an HLB value of 1 (manufactured by Mitsubishi-Kagaku Foods Corporation, trade name: Ryoto Sugar Ester ER-190). The proportion of the fat-based confectionery material in the composite fat-based confectionery was 75% by weight.

### Example 7

A composite fat-based confectionery in which a fat-based confectionery material was sufficiently impregnated into a baked confectionery was obtained by producing in the same manner as in Example 1, except that the sucrose fatty acid ester used was a sucrose erucic acid ester having an HLB value of 2 (manufactured by Mitsubishi-Kagaku Foods Corporation, trade name: Ryoto Sugar Ester ER-290). The proportion of the fat-based confectionery material in the composite fat-based confectionery was 75% by weight.

### Example 8

A baked confectionery and a fat-based confectionery material having a moisture content of 1.8% by weight as in Example 1 were prepared. 100 Parts by weight of the fat-based confectionery material was adjusted to a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, a pressure was applied to 1000 kPa using a pressure resistant container and subsequently returned to the atmospheric pressure, and the baked confectionery was taken out of the fat-based confectionery material. The fat-based confectionery material adhered around the baked confectionery was removed by air blow and the fat-based confectionery material remained on the baked confectionery was solidified under cooling at 15° C. for 25 minutes to obtain a composite fat-based confectionery in which the fat-based confectionery material was sufficiently impregnated into the baked confectionery. The proportion of the fat-based confectionery material in the composite fat-based confectionery was 62% by weight.

### Example 9

A composite fat-based confectionery in which a fat-based confectionery material was sufficiently impregnated into a baked confectionery was obtained by producing in the same manner as in Example 1, except that the sucrose fatty acid ester used was 0.250 parts by weight of a sucrose erucic acid ester (manufactured by Mitsubishi-Kagaku Foods Corporation, trade name: Ryoto Sugar Ester ER-290) having an HLB value of 2 and 0.250 parts by weight of a sucrose stearic acid ester (manufactured by DAI-ICHI KOGYO SEIYAKU CO., LTD., trade name: DK ester F-90) having an HLB value of 9.5. The proportion of the fat-based confectionery material in the composite fat-based confectionery was 75% by weight.

### Example 10

A baked confectionery as in Example 1, and a fat-based confectionery material having a moisture content of 1.8% by weight as in Example 1 was obtained, except that the sucrose fatty acid ester used was 0.250 parts by weight of a sucrose erucic acid ester (manufactured by Mitsubishi-Kagaku Foods Corporation, trade name: Ryoto Sugar Ester ER-290) having an HLB value of 2 and 0.250 parts by weight of a sucrose stearic acid ester (manufactured by DAI-ICHI KOGYO SEIYAKU CO., LTD., trade name: DK ester F-90) having an HLB value of 9.5. 100 Parts by weight of the fat-based confectionery material was adjusted to a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, a pressure was applied to 1000 kPa using a pressure resistant container and subsequently returned to the atmospheric pressure, and the baked confectionery was taken out of the fat-based confectionery material. The fat-based confectionery material adhered around the baked confectionery was removed by air blow and the fat-based confectionery material remained on the baked confectionery was solidified under cooling at 15° C. for 25 minutes to obtain a composite fat-based confectionery in which the fat-based confectionery material was sufficiently impregnated into the baked confectionery. The proportion of the fat-based confectionery material in the composite fat-based confectionery was 62% by weight.

### Comparative Example 1

Using 35.484 parts by weight of hen's egg, 25.806 parts by weight of sugar, 25.806 parts by weight of soft flour, and 12.903 parts by weight of butter, a sponge cake was prepared by a conventional method. The sponge cake was cut to a size of 15 mm×15 mm×50 mm and dried at 100° C. for 30 minutes using a circulation drier to obtain a baked confectionery, which is the dried sponge cake.

A fat-based confectionery material was prepared by a conventional method using 33.400 parts by weight of sugar, 21.000 parts by weight of a vegetable oil and fat, 18.000 parts by weight of cocoa mass, 18.000 parts by weight of whole powder milk, 9.000 parts by weight of cocoa butter, 0.5000 parts by weight of lecithin, and 0.100 parts by weight of a flavor.

0.9 Parts by weight of cow's milk was added to 99.1 parts by weight of the fat-based confectionery material, stirred and mixed to obtain a fat-based confectionery material having a moisture content of 1.3% by weight. 100 Parts by weight of the fat-based confectionery material having a moisture content of 1.3% by weight was adjusted to have a temperature of 35° C., and 3 parts by weight of a seed agent (manufactured by Fuji Oil Co., Ltd., trade name: Choco Seed B) was added thereto and mixed. The fat-based confectionery material was maintained at 35° C., the above baked confectionery was immersed in the fat-based confectionery material while kept at the same condition, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 2

A baked confectionery and a fat-based confectionery material having a moisture content of 1.7% were prepared in the same manner as in Example 1, except that the sucrose stearic acid ester used had an HLB value of 13 (manufactured by DAI-ICHI KOGYO SEIYAKU CO., LTD., trade name: DK ester F-140). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 3

A baked confectionery and a fat-based confectionery material having a moisture content of 1.7% were prepared in the same manner as in Example 1, except that the sucrose stearic acid ester used had an HLB value of 8 (manufactured by DAI-ICHI KOGYO SEIYAKU CO., LTD., trade name: DK ester F-70). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 4

A baked confectionery and a fat-based confectionery material having a moisture content of 1.7% were prepared in the same manner as in Example 1, except that the sucrose stearic acid ester used had an HLB value of 1 (manufactured by DAI-ICHI KOGYO SEIYAKU CO., LTD., trade name: DK ester F-10). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 5

A baked confectionery and a fat-based confectionery material having a moisture content of 1.7% were prepared in the same manner as in Example 1, except that the sucrose stearic acid ester used had an HLB value of 2 (manufactured by DAI-ICHI KOGYO SEIYAKU CO., LTD., trade name: DK ester F-20W). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 6

A baked confectionery and a fat-based confectionery material having a moisture content of 1.7% were prepared in the same manner as in Example 1, except that the sucrose stearic acid ester used had an HLB value of 3 (manufactured by DAI-ICHI KOGYO SEIYAKU CO., LTD., trade name: DK ester F-30). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 7

A baked confectionery and a fat-based confectionery material having a moisture content of 1.7% were prepared in the same manner as in Example 1, except that the sucrose stearic acid ester used had an HLB value of 6 (manufactured by DAI-ICHI KOGYO SEIYAKU CO., LTD., trade name: DK ester F-50). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

### Comparative Example 8

A baked confectionery and a fat-based confectionery material having a moisture content of 1.7% were prepared in the same manner as in Example 1, except that the sucrose stearic acid ester used had an HLB value of 15 (manufactured by DAI-ICHI KOGYO SEIYAKU CO., LTD., trade name: DK ester F-160). The baked confectionery was immersed in the fat-based confectionery material, the pressure was reduced to 15 kPa using a pressure resistant container and immediately returned to the atmospheric pressure, and the baked confectionery was taken out of the fat-based confectionery material. The fat-based confectionery material gathered in the layer form around the baked confectionery and the fat-based confectionery material was scarcely impregnated into the inner portion of the baked confectionery, thereby failing to obtain a composite fat-based confectionery in which the fat-based confectionery material was sufficiently impregnated into the baked confectionery.

1. A composite fat-based confectionery comprising a porous food material impregnated with a fat-based confectionery material containing a nonfat milk solids and having a moisture content of 1% by weight or more, wherein the fat-based confectionery material contains at least one sucrose fatty acid ester selected from the group consisting of a sucrose erucic acid ester and a sucrose stearic acid ester having an HLB value of 9 to 11.

2. The composite fat-based confectionery according to claim 1, wherein a content of the sucrose fatty acid ester in the fat-based confectionery material is 0.1% by weight to 1.0% by weight.

3. The composite fat-based confectionery according to claim 1, wherein the fat-based confectionery material and the porous food material are allowed to contact with each other under a reduced pressure condition and subsequently the pressure is returned to atmospheric pressure or a pressure is applied to a higher pressure than atmospheric pressure to impregnate the porous food material with the fat-based confectionery material.

4. The composite fat-based confectionery according to claim 1, wherein the fat-based confectionery material and the porous food material are allowed to contact with each other under an atmospheric pressure condition and subsequently a pressure is applied to a higher pressure than atmospheric pressure to impregnate the porous food material with the fat-based confectionery material.
